(19) United States
(12) Patent Application Publication
(10) Pub. No.: US 2016/0254717 A1
(43) Pub. Date: Sep. 1, 2016

(54) STATOR FOR ROTARY ELECTRIC MACHINE

(71) Applicants: TOYOTA JIDOSHA KABUSHIKI KAISHA, Toyota-shi, Aichi (JP); AISIN SEIKI KABUSHIKI KAISHA, Kariya-shi, Aichi (JP)

(72) Inventors: Hiroshi HOSHINA, Toyota-shi (JP); Isao KATO, Toyoake-shi (JP)

(73) Assignees: TOYOTA JIDOSHA KABUSHIKI KAISHA, Toyota-shi, Aichi-ken (JP); AISIN SEIKI KABUSHIKI KAISHA, Kariya-shi, Aichi-ken (JP)

(21) Appl. No.: 15/026,716

(22) PCT Filed: Oct. 1, 2014
(86) PCT No.: PCT/JP2014/076868

§ 371 Date: Apr. 1, 2016

(30) Foreign Application Priority Data
Oct. 3, 2013 (JP) 2013-208236

(51) Int. Cl. H02K 3/28

(52) U.S. Cl. CPC H02K 3/28

(57) ABSTRACT

A stator for a rotary electric machine includes a stator core, coils of three phases formed of flat-type wire coils wound around the stator core by concentrated winding, and neutral point bus bars of three phases which are connected to coil terminating ends respectively extending from innermost circumferences of the coils of three phases and are joined together to form a neutral point. Of the neutral point bus bars of three phases, a U-phase neutral point bus bar is shifted radially outward with respect to the innermost circumference of the coil and is thereafter extended outward in the axial direction of the stator, and the neutral point is located radially outward with respect to the innermost circumference of the coil.

### TECHNICAL FIELD

The present invention relates to a stator for use in a rotary electric machine, and particularly to a structure of neutral point bus bars each connected with a terminating end of a coil, and joined to each other to thereby form a neutral point.

### BACKGROUND

A stator of a rotary electric machine generally includes a stator core having a plurality of teeth, and coils of three phases wound around the teeth. Known types of coil windings include concentrated winding for winding a coil between two adjacent slots, and distributed winding for winding a coil between two slots which are apart from each other by at least 3 slots. JP 2013-005541 A (Patent Document 1) and JP 2013-102633 A (Patent Document 2) disclose a stator of a rotary electric machine including coils wound by concentrated winding. In the technology disclosed in Patent Document 1, a flat-type conductive wire is used as the coil, and neutral point bus bars formed by extending respective terminating ends of the coils of three phases are joined to each other, thereby forming a neutral point.

As the terminating end of each coil of three phases is generally located on the innermost circumference of the coil, the neutral point bus bar formed by extending the terminating end is drawn from the innermost circumference of the coil. This neutral point bus bar drawn from the innermost circumference of the coil as described above, in an unstable state not fixed with any fixing component, has a poor shape retention property and therefore has a possibility of being inclined toward the inner circumferential side by a pressure of a mold resin poured for mold fixing and coming into contact with a molding die.

It is therefore an object of the present invention to provide a stator including neutral point bus bars extended from the innermost circumference of coils of three phases and joined to each other to form a neutral point, with an enhanced shape retention property.

### SUMMARY OF INVENTION

In accordance with an aspect of the invention, a stator for a rotary electric machine includes a stator core; coils of three phases formed of flat-type wire coils wound on the stator core by concentrated winding; neutral point bus bars connected to respective coil terminating ends and extending from innermost circumferences of the coils of three phases, respectively; and a neutral point formed by joining the neutral point bus bars of the coils of three phases with each other, and, of the neutral point bus bars of three phases, at least one neutral point bus bar is shifted radially outward with respect to an innermost circumference of the coil and thereafter extends axially outward, and the neutral point is located radially outward with respect to the innermost circumference of the coil.

In accordance with a preferred aspect, of the neutral point bus bars of three phases, neutral point bus bars of two phases extend toward a neutral point bus bar of the remaining phase, and the neutral point bus bar of the remaining phase is shifted radially outward with respect to the innermost circumference of the coil and thereafter extends axially outward.

In accordance with another preferred aspect, the coil of each phase includes a plurality of single coils, each formed by winding a wire coil around one tooth, and the plurality of single coils are connected with each other, the plurality of single coils are arranged such that a first-phase single coil, a second-phase single coil, and a third-phase single coil are sequentially repeated in this order in the circumferential direction, a second-phase neutral point bus bar connected to a terminating end of the second-phase single coil is shifted radially outward with respect to the innermost circumference of the coil and thereafter extends axially outward, and a first-phase neutral point bus bar and a third-phase neutral point bus bar located on both sides of the second-phase single coil in the circumferential direction and connected to the first-phase single coil and the third-phase single coil, respectively, extend toward the first-phase neutral point bus bar. In this case the first-phase neutral point bus bar and the third-phase neutral point bus bar are molded, before being joined, such that each joining portion to be joined to another neutral point bus bar is located toward a base end side of the corresponding bus bar with respect to a joining portion of the second-phase neutral point bus bar, and the first-phase neutral point bus bar and the third-phase neutral point bus bar are joined to the joining portion of the second-phase neutral point bus bar while being elastically deformed such that the joining portions thereof reach the joining portion of the second-phase neutral point bus bar.

According to the present invention, as at least one of the neutral point bus bars of three phases is shifted outward in the radial direction of the stator with respect to the innermost circumference of the coil and thereafter extends outward in the axial direction of the stator, the length of a straight line portion of the neutral point bus bar extending axially is shortened, which makes an inclination of the neutral point bus bar in the radial direction unlikely to occur. Further, as the neutral point bus bar, as a whole, is shifted radially outward, it is unlikely that the neutral point bus bar protrudes inward with respect to the innermost circumference of the coil. As a result, the neutral point bus bars can have an enhanced shape retention property.

### BRIEF DESCRIPTION OF DRAWINGS

FIG. 1 Top view of a stator according to an embodiment of the present invention.

FIG. 2 Enlarged view of a principal portion of the stator.

FIG. 3 Cross sectional view taken along line B-B of FIG. 2.

FIG. 4 View seen from direction A of FIG. 1

FIG. 5 View showing only neutral point bus bars.

FIG. 6 View showing a positional relationship of joining portions of the neutral point bus bars before joining.

FIG. 7 View illustrating another structure of the neutral point bus bar.

FIG. 8 View illustrating another structure of the neutral point bus bar

FIG. 9 Enlarged view of a principal portion of a conventional stator.

FIG. 10 Cross sectional view taken along line C-C of FIG. 9.

### DESCRIPTION OF EMBODIMENTS

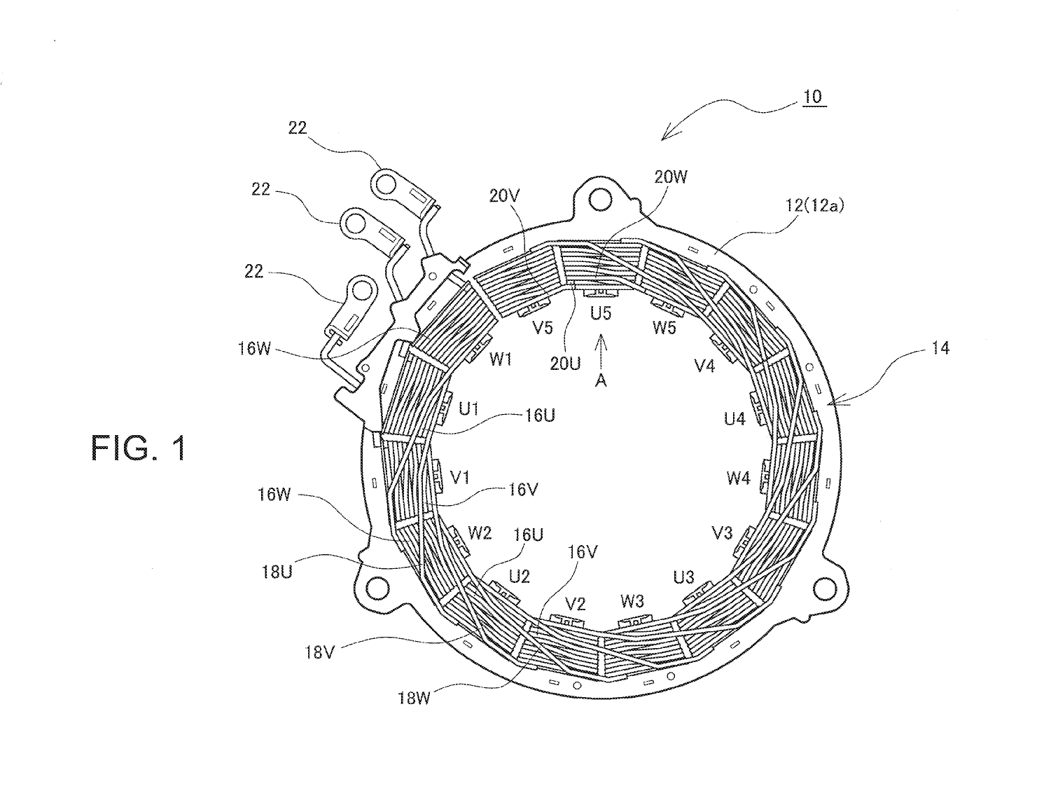

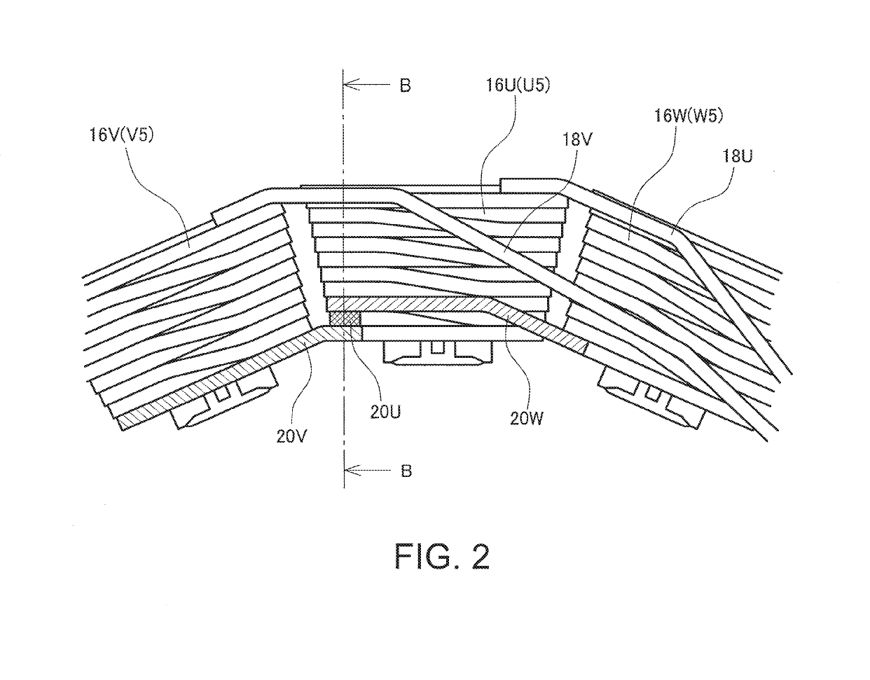

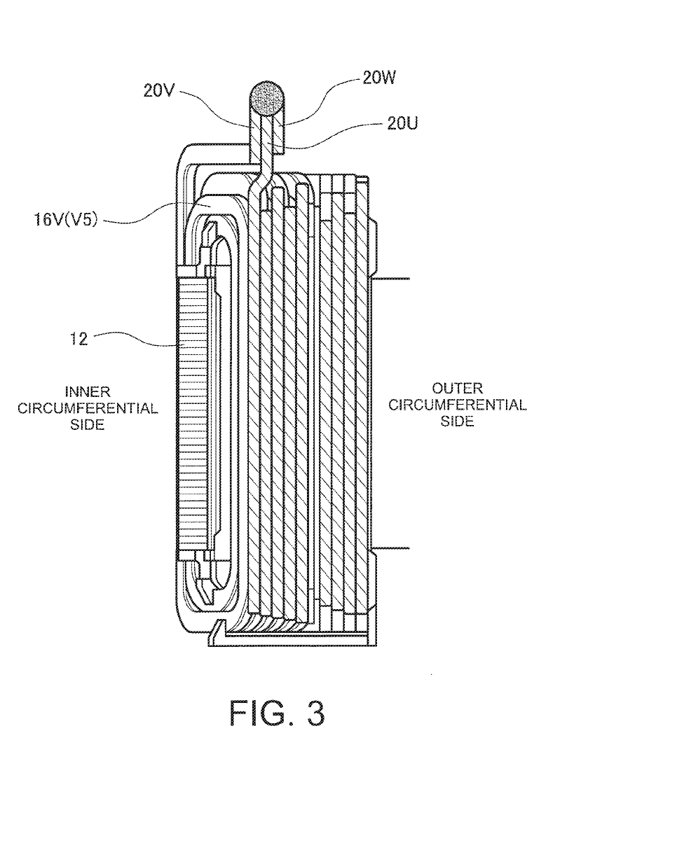

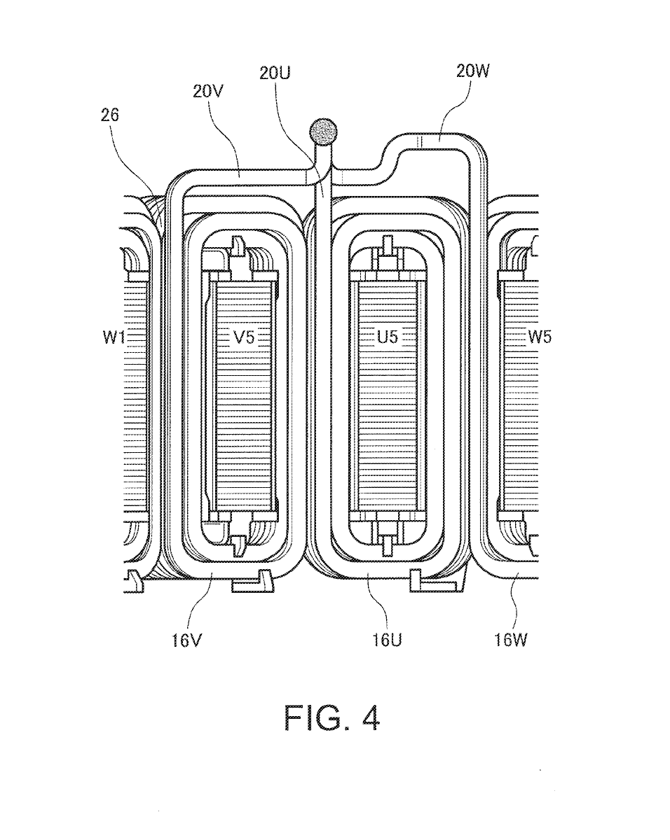

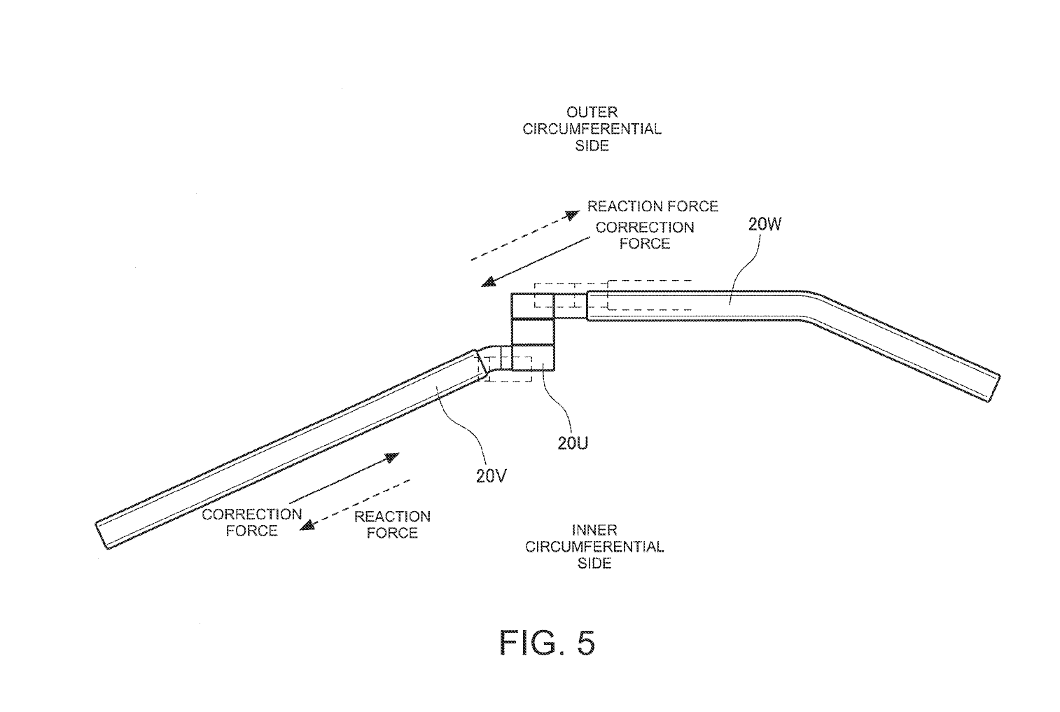

Preferred embodiments of the present invention will be described with reference to the drawings. FIG. 1 is a top view of a stator 10 for use in a rotary electric machine according to an embodiment of the present invention. FIG. 2 is an enlarged view of a principal portion of the stator 10; FIG. 3 is a cross sectional view taken along line B-B of FIG. 2; FIG. 4 is a view seen from A direction of FIG. 1; and FIG. 5 is a view illustrating only neutral point bus bars 20W, 20U, and 20V.

As illustrated in FIG. 1, the stator 10 includes a stator core 12 formed of a layered electromagnetic steel sheet, dust core, and so on, and a stator coil 14 composed of coils 16W, 16U, and 16V of three phases (which will hereinafter be referred to simply as “coil 16” when it is not necessary to discriminate among the three phases, and the same will similarly apply to other components). The stator core 12 includes a back core 12a having a substantially cylindrical shape and a plurality of teeth (which cannot be seen due to the coil 16 in the figure) arranged at equal intervals in the circumferential direction along the inner circumference of the back core 12a. A coil wire is wound around each tooth via an insulating member (not shown) which is provided to electrically insulate the stator coil 14 from the stator core 12.

The stator coil 14 according to the present embodiment is composed of wire coils made of flat-type wire by concentrated winding. Enameling is applied to a surface of the flat-type wire so as to ensure insulation between flat-type wires adjacent to each other. The stator coil 14 includes the coils 16 of three phases; that is, a W-phase coil 16W, a U-phase coil 16U, and a V-phase coil 16V, and each phase coil 16 is composed of one or more (five in the illustrated example) single coils W1 to W5, U1 to U5, and V1 to V5. Each of the single coils W1 to W5, U1 to U5, and V1 to V5 is formed of a wire coil made of flat-type wire wound around a single tooth. In the following description, the single coils W1 to W5, U1 to U5, and V1 to V5 will be referred to W-phase single coils W1 to W5, U-phase single coils U1 to U5, and V-phase single coils V1 to V5 in accordance with the corresponding phases.

A plurality of single coils are set with respect to the stator core 12 such that the W-phase single coils W1 to W5, the U-phase single coils U1 to U5, and the V-phase single coils V1 to V5 are sequentially arranged in this order of phase repeatedly in the circumferential direction of the stator core 12. A single coil of each phase is connected, via an inter-phase-connecting bus bar 18 which is formed by extending an end of the single coil, to another in-phase single coil wound around another tooth. The inter-phase-connecting bus bar 18 is formed by extending an end of each phase single coil on the inner circumferential side, and is connected to an end of another in-phase single coil on the outer circumferential side.

Each of the phase coils 16 formed of a plurality of single coils W1 to W5, U1 to U5, and V1 to V5 that are coupled with each other has a starting end on the outermost circumference of the coil and, and an input terminal 22 is coupled with the starting end. Each phase coil 16 also has a terminating end located on the innermost circumference of the coil. The terminating ends of the respective phase coils 16 are extended to form the neutral point bus bars 20W, 20U, 20V, respectively. The neutral point bus bars 20W, 20U, and 20V of three phases are converged into one location and joined with each other to thereby form a neutral point.

All of the neutral point bus bars 20 of three phases are molded such that they are drawn upward of the coil end from the innermost circumference of the coil 16 and are converged, and are then joined. However, if the neutral point bus bar 20 is simply extended upward (axially outward), the neutral point bus bar 20 has a poor shape retention property. In this case, there is a possibility that the pressure of a mold resin which is poured for mold fixing of the coil end causes the neutral point bus bar 20 to be inclined toward the inner circumferential side and come into contact with a molding die. There is also a possibility that the pressure of the mold resin makes the neutral point bus bar 20 inclined toward the circumferential direction, making it difficult to secure a sufficient phase gap 26.

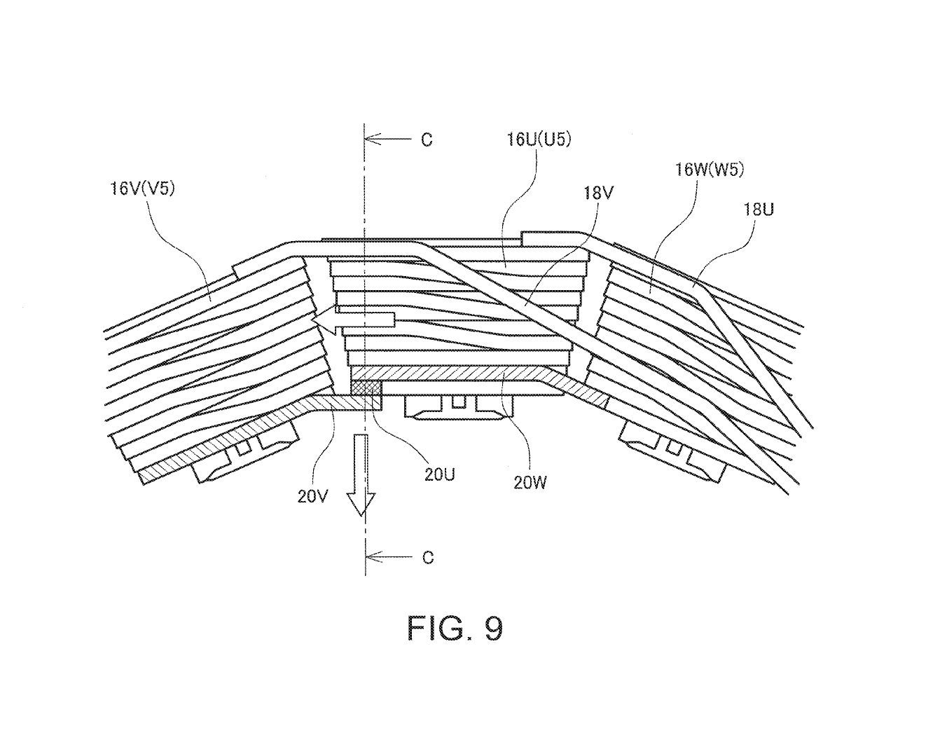

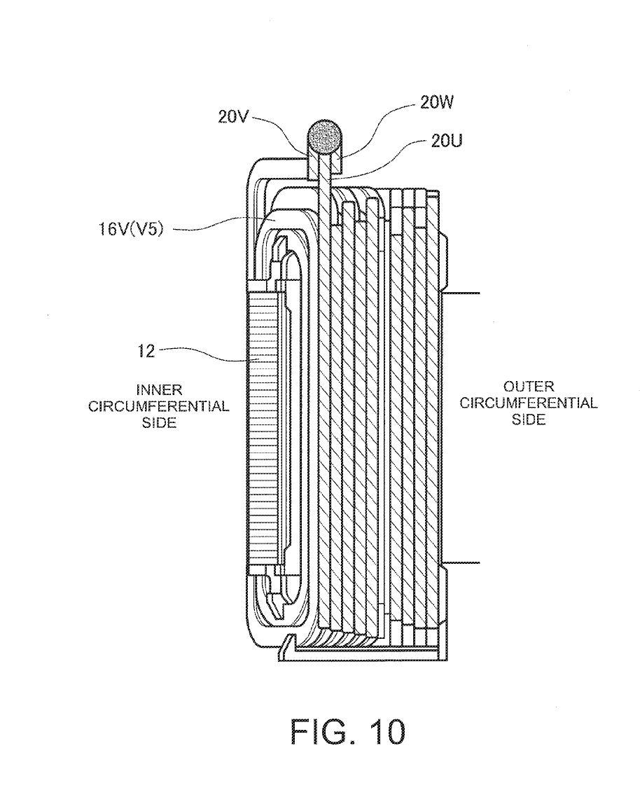

These disadvantages will be described with reference to FIGS. 9 and 10. FIG. 9 is an enlarged view illustrating a principal portion of a conventional stator core 12, and FIG. 10 is a cross sectional view taken along line C-C of FIG. 9. As illustrated in FIG. 9, conventionally, the terminating ends of the V-phase single coil V5, the U-phase single coil U5, and the W-phase single coil W5 located at the trailing ends of the V-phase coil 16V, the U-phase coil 16U, and the W-phase coil 16W, respectively, are extended to form the neutral point bus bars 20, and these neutral point bus bars 20 of three phases are converged and joined to form a neutral point. As the terminating end of each single coil W5, U5, and V5 is located on the innermost circumference of the coil 16, all the neutral point bus bars 20 of three phases are drawn from the innermost circumference of the coil 16.

Conventionally, when converging the neutral point bus bars 20 of three phases, as illustrated in FIG. 10, the neutral point bus bar 20U of U-phase located at the center in the circumferential direction is extended straight upward (axially outward). Further, the V-phase neutral point bus bar 20V is bending-molded in the circumferential direction such that a portion to be joined; that is, a joining portion of the V-phase neutral point bus bar 20V, reaches the joining portion of the U-phase neutral point bus bar 20U on the inner circumferential side and the W-phase neutral point bus bar 20W is bending-molded in the circumferential direction such that the joining portion of the W-phase neutral point bus bar 20W reaches the joining portion of the U-phase neutral point bus bar 20U on the outer circumferential side.

However, when the U-phase neutral point bus bar 20U is extended straight upward as in the conventional art, a relatively small force can make the U-phase neutral point bus bar 20 warped, leading to a possibility that the pressure of the pouring mold resin causes the U-phase neutral point bus bar 20U to be inclined toward the inner circumferential side and come into contact with the molding die.

Further, as is clear from FIG. 1, the W-phase single coil W1 having an input end and the V-phase single coil V5 having the neutral point bus bar 20V are adjacent to each other in the circumferential direction. As there is a great potential difference between the W-phase single coil W1 having an input end and the V-phase single coil V5 having the neutral point bus bar 20V, it is necessary to secure a sufficient gap between these coils W1 and V5 located on both ends; that is, a sufficient phase gap 26 (see FIG. 4). In the conventional art, however, as no special force for shape retention is applied to the neutral point bus bars 20 of three phases, the neutral point bus bars 20 may be inclined in the circumferential direction, which may result in failure to secure a sufficient phase gap 26.

Also, as is clear from FIG. 9, in the conventional art, the joining portion of the V-phase neutral point bus bar 20V is positioned on the inner circumferential side of the joining portion of the U-phase neutral point bus bar 20U drawn straight upward from the innermost circumference of the coil 16. In this case, the V-phase neutral point bus bar 20V projects toward the inner circumferential side with respect to the innermost circumference of the coil 16, leading to another problem that the neutral point comes into contact with the molding die.

According to the present embodiment, the neutral point bus bars 20 having a further enhanced shape retention property are configured, which will be described in detail below with reference to the drawings. As illustrated in FIGS. 2, 4, and 5, according to the present embodiment, as in the conventional art, the neutral point bus bars 20 of three phases are joined to each other in a state where the joining portions of the V-phase and W-phase neutral point bus bars 20V and 20W sandwich the joining portion of the U-phase neutral point bus bar 20U in the radial direction. Also, the U-phase neutral point bus bar 20U extends upward. The joining portions of the V-phase and W-phase neutral point bus bars 20V and 20W connected to the terminating ends of the V-phase single coil V5 and the W-phase single coil W5, respectively, located on both sides of the U-phase single coil U5 in the circumferential direction are extended in the circumferential direction toward the joining portion of the U-phase neutral point bus bar 20U connected to the terminating end of the U-phase single coil. In the present embodiment, however, the U-phase neutral point bus bar 20U does not extend straight upward but is shifted radially outward in the middle. Specifically, according to the present embodiment, the U-phase neutral point bus bar 20U formed by extending the terminating end of the U-phase single coil U5 is bent radially outward at the base portion thereof to be shifted radially outward by an amount corresponding to at least one winding, and thereafter is again bent upward (axially outward). This results in the joining portion of the U-phase neutral point bus bar 20U being shifted radially outward from the innermost circumference of the coil 16 by an amount corresponding to at least one winding.

The joining portion of the V-phase neutral point bus bar 20V is joined to the radially inward side of the joining portion of the U-phase neutral point bus bar 20U. According to the present embodiment, however, as the joining portion of the U-phase neutral point bus bar 20U is shifted radially outward by an amount corresponding to one winding, the joining portion of the V-phase neutral point bus bar 20V does not project toward the inward side with respect to the innermost circumference of the coil 16. This structure results in effective prevention of the neutral point from coming into contact with the molding die.

As the U-phase neutral point bus bar 20U is bent radially outward at the base portion thereof, the length of a straight line portion of the U-phase neutral point bus bar 20U extending straight upward is shorter than that of the conventional art having the U-phase neutral point bus bar 20U which is not bent. Consequently, the neutral point bus bar 20U of the present embodiment having a shorter straight line portion is more unlikely to be warped as compared to the neutral point bus bar 20U of the conventional art when the same voltage is applied, leading to effective prevention of inclination of the neutral point radially inward.

While the amount of shift of the U-phase neutral point bus bar 20U radially outward is not particularly limited, an excessive amount of shift results in an increase in the height of the joining portion of the neutral point bus bar 20 in order to avoid interference with the coil end or an increase in the length of the neutral point bus bar 20 to thereby increase the line resistance, it is desirable to determine the amount of shift in consideration of the height of the coil end and the line resistance.

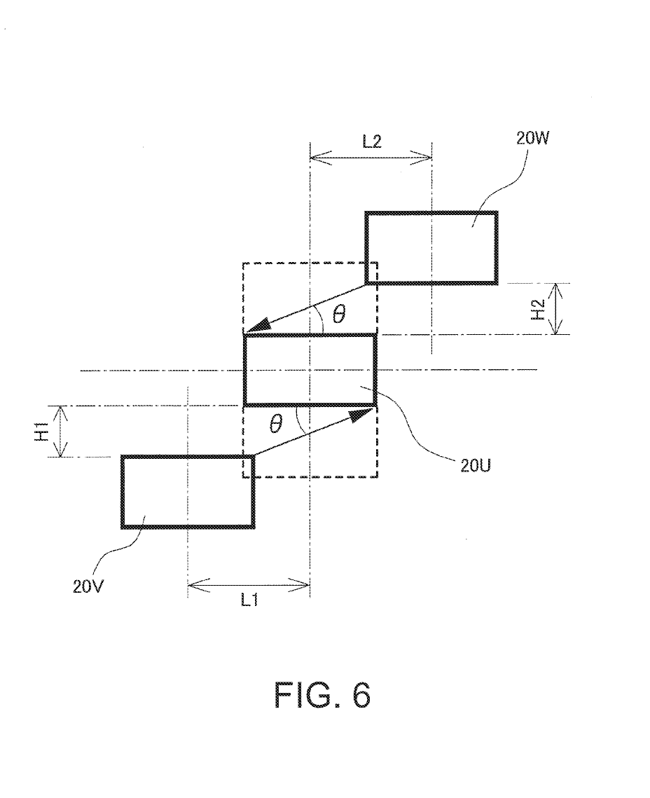

Further, according to the present embodiment, the V-phase and W-phase neutral point bus bars 20V and 20W are first molded such that the joining portions thereof are respectively located toward the base ends from which the V-phase and W-phase neutral point bus bars 20V and 20W are respectively drawn, with respect to the joining portion of the U-phase neutral point bus bar 20U, and then the three joining portions are joined in a state where the joining portions of the V-phase and W-phase neutral point bus bars 20V and 20W are elastically deformed so as to reach the joining portion of the U-phase neutral point bus bar 20U. This will be described with reference to FIGS. 5 and 6. FIG. 5 is a view illustrating only the neutral point bus bars 20 of three-phase. In FIG. 5, a dashed line indicates the shape of the V-phase and W-phase neutral point bus bars 20V and 20W after bending molding of the neutral point bus bars 20 and before joining of the neutral point bus bars 20. FIG. 6 shows the positional relationship of the joining portions of the V-phase, U-phase, and W-phase neutral point bus bars 20 after bending molding and before joining.

The neutral point bus bars 20 are molded into a desired shape by bending molding before joining. According to the present embodiment, as illustrated in FIGS. 5 and 6, after this bending molding and before joining, the V-phase neutral point bus bar 20V is molded such that the joining portion thereof is located apart from the joining portion of the U-phase neutral point bus bar 20U toward the V-phase side in the circumferential direction (toward the base end of V-phase neutral point bus bar 20V) and toward the radially inward side. Similarly, the W-phase neutral point bus bar 20W is molded, after bending molding and before joining, such that the joining portion thereof is located apart from the joining portion of the U-phase neutral point bus bar 20U toward the W-phase side in the circumferential direction (toward the base end of W-phase neutral point bus bar 20W) and toward the radially outward side. In other words, in the present embodiment, both the V-phase and W-phase neutral point bus bars 20V and 20W are molded into a shape having a joining portion which cannot reach the joining portion of the U-phase neutral point bus bar 20U before joining.

The distances L1, H1 and the phase angle θ between the joining portion of the U-phase neutral point bus bar 20U and the joining portion of the V-phase neutral point bus bar 20V are determined such that the neutral point bus bar 20V is not plastically deformed by correction during joining, in consideration of the gap amounts between the coils and between the coil 16 and the insulating member, residual stress of the joining (welding) portion, and so on.

According to the present embodiment, with the V-phase neutral point bus bar 20V being pulled toward the U-phase neutral point bus bar 20U for correction and thus being elastically deformed, the joining portion of the V-phase neutral point bus bar 20V and the joining portion of the U-phase neutral point bus bar 20U are joined to each other. In this case, a reaction force resulting from the elastic restoring force is generated on the joining portion of the U-phase neutral point bus bar 20U (and, by extension, the whole U-phase neutral point bus bar 20U). This reaction force works toward the direction of the joining portion of the V-phase neutral point bus bar 20V; that is, toward the V-phase side in the circumferential direction and toward radially inward side. Consequently, in a state in which only the joining portion of the U-phase neutral point bus bar 20U and the joining portion of the V-phase neutral point bus bar 20V are joined, the U-phase neutral point bus bar 20U is easily inclined toward the V-phase coil 16 side and radially inward by the reaction force.

In the present embodiment, the joining portion of this U-phase neutral point bus bar 20U is further joined to the joining portion of the W-phase neutral point bus bar 20W. The distances L2 and H2 and the phase angle θ between the joining portion of this U-phase neutral point bus bar 20U and the joining portion of the W-phase neutral point bus bar 20W are determined such that the neutral point bus bar 20W is not plastically deformed by correction during joining, in consideration of the gap amounts between the coils and between the coil 16 and the insulating member, residual stress of the joining (welding) portion, and so on. In addition to consideration of the plastic deformation described above, the distances L2 and H2 and the phase angle θ between the joining portion of the U-phase neutral point bus bar 20U and the joining portion of the W-phase neutral point bus bar 20W are also set such that the reaction force generated in the joining portion of the U-phase neutral point bus bar 20U due to the joining to the joining portion of the W-phase neutral point bus bar 20W is balanced with the reaction force generated in the joining portion of the U-phase neutral point bus bar 20U due to the joining to the V-phase neutral point bus bar 20V.

Then, by correcting the W-phase neutral point bus bar 20W and joining the joining portion of this W-phase neutral point bus bar 20W to the joining portion of the U-phase neutral point bus bar 20U, both the reaction force toward the V-phase side in the circumferential direction and the radially inward side and the reaction force toward the W-phase side in the circumferential direction and the radially outward side act on the joining portion of the U-phase neutral point bus bar 20U. With the forces in the opposite directions and with substantially the same magnitudes acting on the joining portion of the U-phase neutral point bus bar 20U in this manner, the position of the joining portion of the U-phase neutral point bus bar 20U is stabilized, so that inclination of the U-phase neutral point bus bar 20U in the radial direction and the circumferential direction can be advantageously prevented. This results in effective prevention of the neutral point coming into contact with the molding die, so that sufficient phase gap 26 can be ensured more reliably.

As described above, according to the present embodiment, by shifting the U-phase neutral point bus bar 20U radially outward, the shape retention property of the neutral point bus bar 20 is enhanced, so that protrusion of the neutral point toward the inner circumferential side with respect to the innermost circumference of the coil 16 can be effectively prevented. Further, according to the present embodiment, the V-phase and W-phase neutral point bus bars 20V and 20W are molded such that the joining portions thereof are located toward the base ends of the V-phase and W-phase neutral point bus bars 20V and 20W, respectively, with respect to the joining portion of the U-phase neutral point bus bar 20U, and in a state where the V-phase and W-phase neutral point bus bars 20V and 20W are corrected and elastically deformed such that the joining portions of the V-phase and W-phase neutral point bus bars 20V and 20W can reach the joining portion of the U-phase neutral point bus bar 20U, the joining portions of three phases are joined together. This structure further enhances the shape retention property of the neutral point bus bars 20, thereby further reliably preventing inclination of the neutral point bus bar 20 radially inward and toward the circumferential direction.

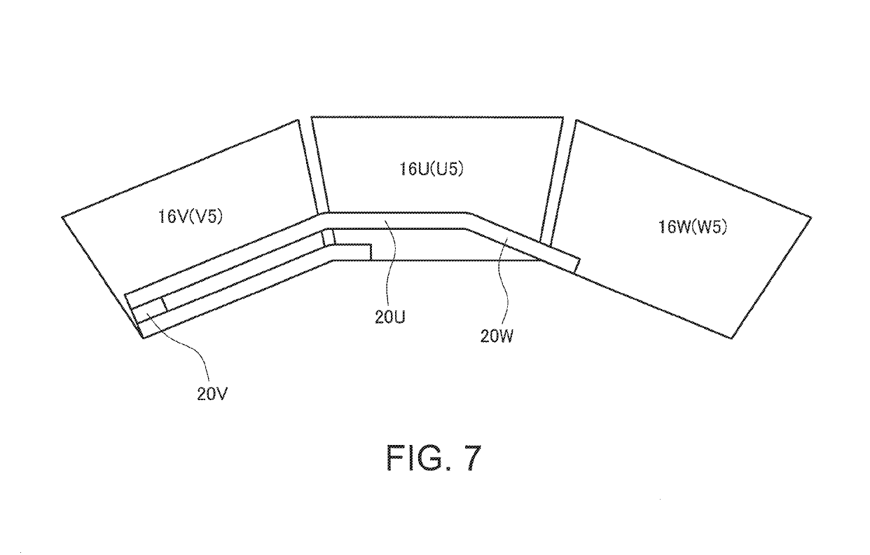

It should be noted that each of the structures described above is only an example, and any other structures may also be adopted as long as the neutral point bus bar 20 of at least one phase, among the neutral point bus bars 20 of three-phases to be joined, is shifted radially outward. For example, while, in the above example, of the neutral point bus bars 20 of three phases, the neutral point bus bars 20 on both sides of the neutral point bus bar 20 connected to the single coil located in the center in the circumferential direction are radially extended toward the neutral point bus bar 20 in the center, as illustrated in FIG. 7, it is also possible to shift the neutral point bus bar 20V connected to the single coil V5 located at the end in the circumferential direction, among the single coils W5, U5, and V5 of three-phases forming the respective terminating ends of the phase coil, radially outward and to bend the neutral point bus bars 20U and 20W of the remaining two phases connected to the single coils U5 and W5 in the circumferential direction. In this case, as the length of the straight line portion of the neutral point bus bar 20V extending upward is similarly shortened, it is possible to effectively prevent the inclination of the neutral point bus bar 20 radially inward.

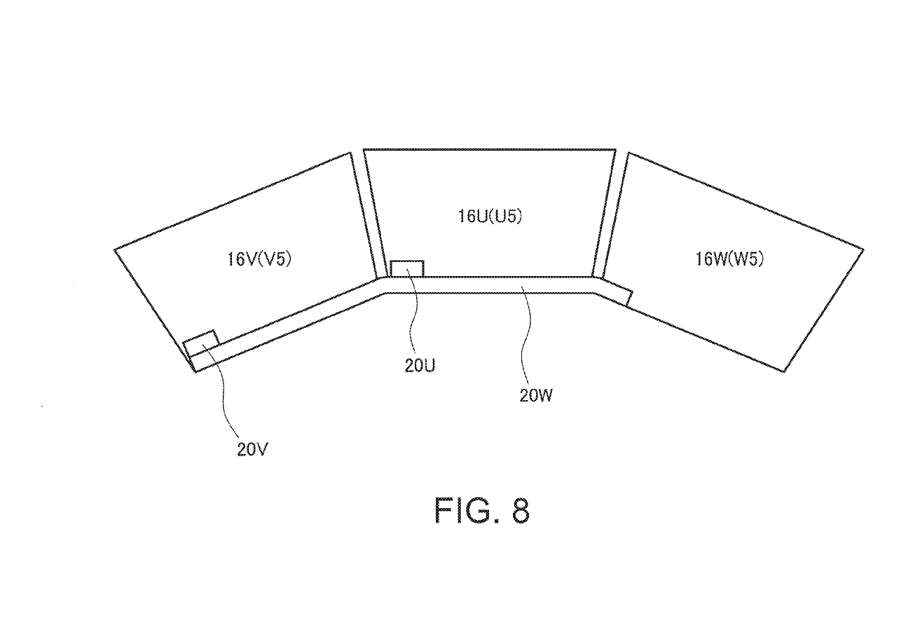

Further, while, in the above example, the neutral point bus bars 20 of three phases are converged into one location for joining, the neutral point bus bars 20 need not necessarily be joined at one location, so long as the neutral point bus bars 20 of three phases are connected. For example, as illustrated in FIG. 8, it is possible to shift the neutral point bus bars 20U and 20V radially outward and thereafter extend these neutral point bus bars 20U and 20V upward, and then join the neutral point bus bars 20U and 20V to the intermediate portion and the leading end, respectively, of the remaining neutral point bus bar 20W extended in the circumferential direction In this case, as the neutral point bus bars 20U and 20V extended upward are shifted radially outward in the middle, it is possible effectively prevent inclination of the neutral point bus bar 20 radially inward.

1. A stator for a rotary electric machine, the stator comprising
a stator core;
coils of three phases formed of flat-type wire coils wound on the stator core by concentrated winding;
neutral point bus bars connected to respective coil terminating ends and extending axially outward from innermost circumferences of the coils of three phases, respectively; and
a neutral point formed by joining the neutral point bus bars of the coils of three phases with each other,
wherein
of the neutral point bus bars of three phases, at least one neutral point bus bar is shifted radially outward with respect to an innermost circumference of the coil as the at least one neutral point bus bar extends axially outward from the coil terminating end and
the neutral point is located radially outward with respect to the innermost circumference of the coil.

2. The stator for a rotary electric machine according to claim 1, wherein
of the neutral point bus bars of three phases, neutral point bus bars of two phases extend toward a neutral point bus bar of the remaining phase, and the neutral point bus bar of the remaining phase is shifted radially outward with respect to the innermost circumference of the coil and thereafter extends axially outward.

3. The stator for a rotary electric machine according to claim 1, wherein
the coil of each phase includes a plurality of single coils, each formed by winding a wire coil around one tooth, the plurality of single coils being connected with each other,
the plurality of single coils are arranged such that a first-phase single coil, a second-phase single coil, and a third-phase single coil are sequentially repeated in this order in the circumferential direction,
a second-phase neutral point bus bar connected to a terminating end of the second-phase single coil is shifted radially outward with respect to the innermost circumference of the coil and thereafter extends axially outward, and
a first-phase neutral point bus bar and a third-phase neutral point bus bar located on respective sides of the second-phase single coil in the circumferential direction and connected to the first-phase single coil and the third-phase single coil, respectively, extend toward the second-phase neutral point bus bar.

4. The stator for a rotary electric machine according to claim 2, wherein
the coil of each phase includes a plurality of single coils, each formed by winding a wire coil around one tooth, the plurality of single coils being connected with each other,
the plurality of single coils are arranged such that a first-phase single coil, a second-phase single coil, and a third-phase single coil are sequentially repeated in this order in the circumferential direction,
a second-phase neutral point bus bar connected to a terminating end of the second-phase single coil is shifted radially outward with respect to the innermost circumference of the coil and thereafter extends axially outward, and
a first-phase neutral point bus bar and a third-phase neutral point bus bar located on respective sides of the second-phase single coil in the circumferential direction and connected to the first-phase single coil and the third-phase single coil, respectively, extend toward the second-phase neutral point bus bar.

5. The stator for a rotary electric machine according to claim 3, wherein
the first-phase neutral point bus bar and the third-phase neutral point bus bar are molded, before being joined, such that each joining portion to be joined to another neutral point bus bar is located toward a base end side of the corresponding bus bar with respect to a joining portion of the second-phase neutral point bus bar, and
the first-phase neutral point bus bar and the third-phase neutral point bus bar are joined to the joining portion of the second-phase neutral point bus bar while being elastically deformed such that the joining portions thereof reach the joining portion of the second-phase neutral point bus bar.

6. The stator for a rotary electric machine according to claim 4, wherein
the first-phase neutral point bus bar and the third-phase neutral point bus bar are molded, before being joined, such that each joining portion to be joined to another neutral point bus bar is located toward a base end side of the corresponding bus bar with respect to a joining portion of the second-phase neutral point bus bar, and
the first-phase neutral point bus bar and the third-phase neutral point bus bar are joined to the joining portion of the second-phase neutral point bus bar while being elastically deformed such that the joining portions thereof reach the joining portion of the second-phase neutral point bus bar.
